(19) United States
(12) Patent Application Publication
(10) Pub. No.: US 2004/0058293 A1
(43) Pub. Date: Mar. 25, 2004

(54) Assembly line processing system

(76) Inventors: Tue Nguyen, Fremont, CA (US); Tai Dung Nguyen, Fremont, CA (US); Craig Alan Bercaw, Los Gatos, CA (US)

Correspondence Address: Tue Nguyen, 496 Olive Ave., Fremont, CA, 94539, US

(21) Appl. No.: 10/212,545

(22) Filed: Aug. 6, 2002

(51) Int. Cl. F27B 9/02

(52) U.S. Cl. 432/129; 432/133; 432/163; 432/171

(57) ABSTRACT

An apparatus for sequential processing of a workpiece comprises an assembly line processing system. The apparatus comprises multiple workpieces moving in an assembly line fashion under multiple process stations. The multiple process stations provide different processes onto the workpieces for a sequential processing of the workpieces. The sequential processing action is carried out by the movement of the workpieces under the various process stations.

### BACKGROUND

The present invention relates to sequential thin film processing.

The fabrication of modern semiconductor workpiece structures has traditionally relied on plasma processing in a variety of operations such as etching and deposition. Plasma etching involves using chemically active atoms or energetic ions to remove material from a substrate. Deposition techniques employing plasma include Chemical Vapor Deposition (CVD) and Physical Vapor Deposition (PVD) or sputtering. PVD uses a high vacuum apparatus and generated plasma that sputters atoms or clusters of atoms toward the surface of the wafer substrates. PVD is a line of sight deposition process that is more difficult to achieve conformal film deposition over complex topography such as deposition of a thin and uniform liner or barrier layer over the small trench or via of 0.13 μm or less, especially with high aspect ratio greater than 4:1. Plasma generation methods include parallel plate plasma, inductive coupled plasma (ICP), remote plasma, microwave plasma. In parallel plate plasma, a power source is applied across two parallel plates to create an electric field which will ionize the gas to generate the plasma. The plasma is confined between the parallel plates where the electric field is strongest, and there is significant plasma bombardment due to the presence of the electric field. In inductive coupled plasma, a power source is applied to a coil to create a magnetic field which will ionize the gas to generate the plasma. A non-conducting window such as ceramic plate could be used to separate the plasma source from the plasma. Care should be taken so that no metal is deposited on the non-conducting window, otherwise the deposited metal will block the magnetic field, and the plasma will be extinguished. This is the reason why inductive coupled plasma was not used for metal deposition. Typical parallel plate plasma and inductive coupled plasma use radio frequency (RF) power sources. In remote plasma, a plasma is generated elsewhere and then being brought to the process chamber. In microwave plasma, the plasma uses microwave frequency (MW) power source. Microwave plasma tends to be remote plasma, and is brought to the process chamber using microwave guide. Plasma processing can be used for sputtering thin film deposition, such as metal sputtering or dielectric sputtering. Plasma processing can be used for plasma etching.

In CVD processing, a gas or vapor mixture is flowed over the wafer surface that is kept at an elevated temperature. Reactions then take place at the hot surface where deposition takes place. Temperature of the wafer surface is an important factor in CVD deposition, as it depends on the chemistry of the precursor for deposition and affects the uniformity of deposition over the large wafer surface. CVD typically requires high temperature for deposition which may not be compatible with other processes in the semiconductor process. CVD at lower temperature tends to produce low quality films in terms of uniformity and impurities.

In a deposition technology, similar to the CVD technique, known as atomic layer deposition (ALD), various gases are injected into the chamber for as short as 100-500 milliseconds in alternating sequences. For example, a first gas is delivered into the chamber for about 500 milliseconds and the substrate is heated, then the first gas (heat optional) is turned off. The residue from the first gas is then evacuated. Another gas is delivered into the chamber for another 500 milliseconds (heat optional). The residue from this gas is also evacuated before the next gas is delivered for about 500 milliseconds (and optionally heated). This sequence is done until all gases have been cycled through the chamber, each gas sequence typically forms a monolayer which is highly conformal. ALD technology thus pulses gas injection and heating sequences that are between 100 and 500 milliseconds. This approach has a high dissociation energy requirement to break the bonds in the various precursor gases such as silane and oxygen and thus requires the substrate to be heated to a high temperature, for example in the order of 600-800 degree Celsius for silane and oxygen processes.

ALD also uses radical generators, such as plasma generators, to increase the reactivity of the second gas and effectively the reaction between the fist and the second gases at the substrate. U.S. Pat. No. 5,916,365 to Sherman entitled “Sequential chemical vapor deposition” provides for sequential chemical vapor deposition by employing a reactor operated at low pressure a pump to remove excess reactants, and a line to introduce gas into the reactor through a valve. Sherman exposes the part to a gaseous first reactant, including a non-semiconductor element of the thin film to be formed, wherein the first reactant adsorbs on the part. The Sherman process produces sub-monolayer per gas injection due to adsorption. The first reactant forms a monolayer on the part to be coated (after multiple cycles), while the second reactant passes through a radical generator which partially decomposes or activates the second reactant into a gaseous radical before it impinges on the monolayer. This second reactant does not necessarily form a monolayer but is available to react with the deposited monolayer. A pump removes the excess second reactant and reaction products completing the process cycle. The process cycle can be repeated to grow the desired thickness of film.

There is other applications using plasma in ALD process. U.S. Pat. No. 6,200,893 to Sneh entitled “Radical-assisted sequential CVD” discusses a method for CVD deposition on a substrate wherein radical species are used in alternate steps to depositions from a molecular precursor to treat the material deposited from the molecular precursor and to prepare the substrate surface with a reactive chemical in preparation for the next molecular precursor step. By repetitive cycles a composite integrated film is produced. In a preferred embodiment the depositions from the molecular precursor are metals, and the radicals in the alternate steps are used to remove the ligands left from the metal precursor reactions, and to oxidize or nitride the metal surface in subsequent layers.

In one embodiment taught by Sneh, a metal is deposited on a substrate surface in a deposition chamber by (a) depositing a monolayer of metal on the substrate surface by flowing a molecular precursor gas or vapor bearing the metal over a surface of the substrate, the surface saturated by a first reactive species with which the precursor will react by depositing the metal and forming reaction product, leaving a metal surface covered with ligands from the metal precursor and therefore not further reactive with the precursor; (b) terminating flow of the precursor gas or vapor; (c) purging the precursor with an inert gas; (d) flowing at least one radical species into the chamber and over the surface, the radical species is highly reactive with the surface ligands of the metal precursor layer and eliminates the ligands as reaction product, and saturates the surface, providing the first reactive species; and (e) repeating the steps in order until a metallic film of desired thickness results.

In another Sneh aspect, a metal nitride is deposited on a substrate surface in a deposition chamber by (a) depositing a monolayer of metal on the substrate surface by flowing a metal precursor gas or vapor bearing the metal over a surface of the substrate, the surface saturated by a first reactive species with which the precursor will react by depositing the metal and forming reaction product, leaving a metal surface covered with ligands from the metal precursor and therefore not further reactive with the precursor; (b) terminating flow of the precursor gas or vapor; (c) purging the precursor with inert gas; (d) flowing a first radical species into the chamber and over the surface, the atomic species highly reactive with the surface ligands of the metal precursor layer and eliminating the ligands as reaction product and also saturating the surface; (e) flowing radical nitrogen into the chamber to combine with the metal monolayer deposited in step (a), forming a nitride of the metal; (f) flowing a third radical species into the chamber terminating the surface with the first reactive species in preparation for a next metal deposition step; and (g) repeating the steps in order until a composite film of desired thickness results.

The Sneh embodiments thus deposit monolayers, one at a time. This process is relatively time-consuming as a thick film is desired.

Other application of sequential deposition is nanolayer thick film deposition (NLD), U.S. patent application Ser. No. 09/954,244 on Sep. 10, 2001 by the same authors, Tue Nguyen et al. NLD is a process of depositing a thin film by chemical vapor deposition, including the steps of evacuating a chamber of gases, exposing a workpiece to a gaseous first reactant, wherein the first reactant deposits on the workpiece to form the thin film, then evacuating the chamber of gases, and exposing the workpiece, coated with the first reactant, to a gaseous second reactant under plasma, wherein the thin film deposited by the first reactant is treated to form the same materials or a different material.

In comparison with CVD, atomic layer deposition (ALD or ALCVD) is a modified CVD process that is temperature sensitive and flux independent. ALD is based on self-limiting surface reaction. ALD provides a uniform deposition over complex topography and temperature independent since the gases are adsorbed onto the surface at lower temperature than CVD because it is in adsorption regime.

As discussed in Sherman and Sneh, the ALD process includes cycles of flowing gas reactant into the chamber, adsorbing one sub-monolayer onto the wafer surface, purging the gas reactant, flowing a second gas reactant into the chamber, and reacting the second gas reactant with the first gas reactant to form a monolayer on the wafer substrate. Thick film is achieved by deposition f multiple cycles.

Precise thickness can be controlled by number of cycles since monolayer is deposited per cycle. However, the conventional ALD method is slow in depositing films such as those around 100 angstroms in thickness. Growth rate of ALD TiN for example was reported at 0.2 angstrom/cycle, which is typical of metal nitrides from corresponding chlorides and NH₃.

The throughput workpiece fabrication for a conventional ALD system is slow. Even if the chamber is designed with minimal volume, the throughput is still slow due to the large number of cycles required to achieve the thickness. The pump/purge cycle between gases is very time consuming, especially with liquid or solid vapors. Conventional ALD is a slower process than CVD with a rate of deposition almost 10 times as slow as CVD deposition. The process is also chemical dependent to have the proper self-limiting surface reaction for deposition. To improve the throughput, a batch system has been developed to process many wafers at the same time.

As with other sequential processing methods, the precursor gases or vapors are introduced sequentially with a pump/purge step in between to ensure the complete removal of the precursor. This pump/purge step does not contribute to the film process, therefore it is desirable if one would be able to remove this step from the processing sequence.

### SUMMARY

Accordingly, an assembly line processing system apparatus for assembly-line style sequential processing is disclosed. The present invention discloses an assembly line processing system apparatus with much improved throughput compared with an apparatus processing only one workpiece. The present invention discloses an apparatus with similar throughput as a batch apparatus which can process many workpieces at the same time. However, the present invention uses an assembly line technique to process many workpieces, one after the other, not all at the same time as in batch system. With the assembly line technique, the sequential process becomes natural because the workpiece is processed sequentially when it moved through the assembly line. The on-off cycle of the precursors employed in typical sequential systems is not needed in the present invention assembly line system.

One aspect of the present invention assembly line system apparatus is the sequential processing of a workpiece without the pulsing of the flow of the precursors. The workpieces are positioned on a movable workpiece conveyor, which comprises multiple workpiece supports, each adapted to carry a workpiece. The movable workpiece conveyor is capable of continously and repeatably running in a close-loop path, therefore each workpiece is passing the same position a number of times. There are at least two process stations positioned along the close-loop path of the workpiece conveyor to provide two different processes onto the workpieces. With the two process stations providing different processes to the workpiece, the workpiece is processed sequentially in an assembly line fashion, firstly from the first process station, and secondly from the second process station, when the conveyor is moving one cycle along the close-loop path. By repeatably moving the conveyor along the close-loop path with the process station under operating conditions, the workpieces positioned on the conveyor are processed a plurality of cycles, with each cycle defined by the sequentially processes of the different process stations.

The process delivered to the workpiece from the process station comprises delivering a plurality of precursors onto the workpieces. An example of sequential process is that the first process station provides the precursor of trimethyl aluminum (TMA) vapor. TMA precursor adsorbed onto the surface of the workpiece when the workpiece passes by the first process station. The second process station provides the precursor of ozone vapor. When the workpiece passes by the second process station, ozone precursor reacts with TMA on the surface of the workpiece to form a thin film of aluminum oxide on the workpiece. By repeatable moving the workpiece, a multiple layers of aluminum oxide is formed on the workpiece. The thickness of the aluminum oxide thin film is controlled by the number of cycles that the workpiece passes through the process station. The precursor flows, TMA and ozone, can be continuous and need not be pulsed as in the case of ALD processing. The sequential process is taken care of by the action of the moving conveyor, exposing the workpiece sequentially to TMA precursor and then to ozone precursor, and then back to TMA precursor.

A typical assembly line sequential deposition comprises the following steps:

a) A number of workpieces is loaded into the workpiece conveyor. The workpieces are position on the workpiece supports. There might be empty positions in the workpiece conveyor, e.g. each workpiece support does not necessarily have a workpiece.

b) The first process station is turned on.

c) The conveyor moves to process the workpieces under the first process station.

d) When the workpieces, which already processed under the first station, reach the second process station, the second process station is turned on. This operation offset of the second process station at the beginning of the process sequence ensures that all the workpieces having the same process sequence.

e) The conveyor moves a number of cycles. The number of cycles determines the thickness of the thin film to be deposited.

f) The first process station is turned off before the second process station. This operation offset of the first process station at the end of the process sequence ensures that all the workpieces having the same process sequence.

g) The second process station is turned off.

h) The conveyor stops and all the workpieces are unloaded from the conveyor.

The sequential processing of the workpieces in the present invention assembly line processing system does not required that the process flows of the process stations to be interrupted. The sequential processing is performed by the assembly line action.

The processing of the workpiece can be a deposition of a thin film, or an adsorption of a sub-monolayer of a plurality of precursors or reactants, or an etching of a thin layer, or a reaction, with or without an exciting source such as a plasma source, of a plurality of precursors or reactants onto the existing layers on the workpiece.

Implementations of the above aspect may include one or more of the following.

The workpiece can be a semiconductor wafer. While the present invention is perfectly suitable for semiconductor processing, it also can be used for processing in other fields, such as hardness coating for tools, chamber coating for modifying chamber surface characteristics.

The process station can deliver the precursors from the side of the workpiece, or from the top of the workpiece. The outlets of the precursor flows from the process station can be a round injector, a linear injector or a showerhead injector. Since the workpiece is moving, a linear injector perpendicular to the movement direction is adequate to ensure uniform distribution of the precursors onto the workpiece. A showerhead injector can be oblong and still provides the same uniform flow distribution as a round showerhead because of the moving workpiece.

The apparatus can further comprise a plurality of isolation stations positioned between the process stations to minimize cross contamination between the process stations. The precursors from the process stations react together at the workpiece surface, but it is desirable to keep these precursors separate as not to create possible gas phase reaction, causing particles, or deposition on unwanted surfaces such as chamber walls. The isolation station can comprise a plurality of pumping systems, to remove the precursors from the surrounding process stations. The isolation station can comprise a plurality of purging systems, to provide non-reactive gas, such as an inert gas, between the surrounding process stations to create a gas curtain for isolation purpose. The isolation station can comprise a purging system between the surrounding two process stations, together with two pumping systems between the process station and the purging system to improve the isolation between the process stations. The isolation station can surround the process station to capture the precursor flows from the process station in all directions.

The workpiece support can be recessed to create a cavity. The cavity captures the precursors from one process station and carries the precursors along the conveyor path to increase the retention time of the precursors to the workpiece. This cavity design will need a pump/purge system to prevent the precursors from moving from one process station to the other process station. The workpiece support can be flushed with the workpiece exposed. This design will not extend the retention time of the precursors when the workpiece is moving from one process station to the other process station, but the need for pump/purge system to prevent cross contamination is much reduced.

The apparatus can be processed in sub-atmospheric pressure. The movable conveyor can be covered by an enclosed chamber connected to a vacuum pump system to maintain the enclosed chamber at a sub-atmospheric pressure. The vacuum pump system can also be used as an isolation station. The enclosed chamber can have a throttle valve to regulate the pressure in the chamber.

The movable workpiece conveyor can be a conveyor belt to move the workpieces along a close-loop path. The conveyor can be a rotatable platform, rotated with respect to an axis at the center of the platform.

The apparatus can further comprise a plurality of load-or-unload stations, to load or unload the workpiece netween the load-or-unload stations and the workpiece supports. The load-or-unload station can performed both loading and unloading actions, or only loading action, or only unloading action. In an aspect of the invention where the apparatus can be processed at sub-atmospheric pressure, the apparatus can further comprise an external pathway between the enclosed chamber and the load-or-unload stations. The external pathway also can comprise a gate valve for vacuum isolation.

The apparatus can further comprises a plurality of workpiece heaters coupled to the workpiece support. The workpiece heaters are capable of heating the workpiece to an elevated temperature. The workpiece heaters are a part of the process requirements. Some processes require that the workpiece be heated to an elevated temperature, while other processes can run at room temperature and other processes need to run below room temperature. The workpiece heater can be radiative heater such as a lamp, or resistive heater.

The apparatus can further comprise a plurality of heating stations to provide thermal energy to the workpieces. Besides the workpiece heaters coupled to the workpiece support, the heating station is another way to heat the workpiece to an elevated temperature. The heating station can comprise a radiative heater such as a tungsten halogen lamp. The heating lamp can be a linear lamp, positioned perpendicular to the conveyor movement. Due to motion of the workpiece, a linear lamp can provide good uniform heating to the workpiece.

The apparatus can further comprise a plurality of laser stations to provide laser energy to the workpieces. Laser energy can promote the reaction between the precursors supplied to the workpieces. The laser station can comprise a linear laser beam positioned perpendicular to the conveyor movement. Due to motion of the workpiece, a linear laser beam can provide good uniform energy to the workpiece.

The apparatus can further comprise a plurality of workpiece lift to separate the workpiece from the workpiece support. The workpiece lift can be a 3-pin actuator to lift the workpiece. After the workpiece is separated from the workpiece support, a blade can be inserted under the workpiece and lift the workpiece up and remove the workpiece to a load-or-unload station.

The process station can comprise a plurality of delivery systems to provide a plurality of precursors onto the workpieces. The delivery systems are a part of the process requirements. The delivery system can be a gaseous delivery system where the precursors to be delivered onto the workpieces are stored in gaseous form. The delivery system can be a liquid precursor delivery system where the precursors are stored in liquid form and delivered onto the workpieces in vapor form. The liquid delivery system can be a bubbler system where the vapor is draw from the liquid container, with or without the help of a bubbler. The liquid delivery system can be a liquid injection system where the liquid is draw from the liquid container and then converted to vapor form using a vaporizer. The delivery system can be a solid precursor delivery system where the precursors are stored in solid form and delivered onto the workpieces in vapor form. The delivery system can comprise a vaporizer to vaporize a liquid precursor or a solid precursor. The delivery system can comprise a liquid flow controller to control the amount of liquid precursor flow. The delivery system can comprise a mass flow controller to control the amount of vapor precursor flow. The delivery system can comprise a number of valves to control the timing of the precursor delivery.

The apparatus can further comprise a plurality of plasma stations to provide plasma energy to the workpieces. Plasma energy can promote the reaction between the precursors supplied to the workpieces. The plasma can be used to excite the precursors, generating radical species, and increase the reaction rate. The plasma can be used for deposition processes, reaction processes, etching processes, or chamber clean processes. The plasma source can be an inductive coupled plasma source using radio frequency (RF). The plasma source can be a parallel plate plasma source using radio frequency (RF). The plasma source can be a remote plasma source. The plasma source can be a microwave plasma source using microwave frequency (MW).

The process stations can comprise a plurality of plasma generators to energize the precursors, excite the precursors, generate radical species, and increase the reaction rate.

The apparatus can further comprises a plurality of workpiece bias power sources coupled to the workpiece supports. The workpiece bias power source can be a direct current (DC) bias source, or a RF bias source. The workpiece bias power source can provide a potential bias to the workpiece to modify the path of the charged precursors, to provide bombardment to the workpiece.

In a preferred embodiment, the present invention apparatus comprises a enclosed chamber being vacuum-tight to allow processing under sub-atmospheric pressure. The enclosed chamber covers a rotatable workpiece conveyor. The rotatable workpiece conveyor defines a close-loop processing path and comprises multiple workpiece supports with each workpiece support adapted to carry a workpiece. The conveyor is capable of continuously and repeatably moving the workpiece supports and the workpieces along the close-loop processing path. The apparatus further comprises at least two process stations coupled to the enclosed chamber. The process stations are positioned along the closed-loop processing path to provide a process onto the workpieces when the workpieces pass through the process stations. The process stations deliver a plurality of precursors onto the workpieces. When the workpieces are moving along the closed-loop processing path, the process stations provides sequential processes onto the workpieces. The apparatus further comprises a motor system to move the rotatable workpiece conveyor along the closed-loop processing path. The apparatur further comprises a plurality of isolation stations. The isolation stations are positioned between the process stations to minimize cross contamination between the process stations. The apparatus further comprises a plurality of load-or-unload stations to load or unload the workpieces onto the workpiece supports. Therefore by repeatably moving the rotatable workpiece conveyor along the closed-loop processing path with the process stations under operating conditions, a plurality of workpieces positioned on the rotatable workpiece conveyor are processed in an assembly line fashion with the workpieces being processed sequentially by different process stations and the workpieces being processed a plurality of cycles by the closed-loop processing path.

The process station can comprise a deposition system to deposit a thin film on the workpiece such as CVD deposition, ALD deposition, plasma enhanced CVD deposition, metal organic CVD (MOCVD) deposition, sputtering deposition. A sputter deposition system can sputter deposit a thin film on the workpiece. A plasma enhanced deposition can deposit a thin film on the workpiece. The process station can comprise a treatment system to treat an existing thin film on the workpiece such as rapid thermal annealing, laser annealing, plasma annealing, desorption, reaction. The process station can comprise an etching system for etching an existing thin film of the workpiece such as metal etch, oxide etch, atomic layer etch. A plasma etch station can provide a plasma etch process to the workpiece. A combination of various stations can provide multiplayer sequential process to a workpiece such as a sequence of deposition/etch/deposition/etch processes to enhance the conformality, or to control the film property.

In a co-pending application by the same authors, Tue Nguyen et al., entitled “Assembly line processing method”, a method of sequential process of a workpiece is disclosed. The operating conditions for the assembly line processing system for sequentially deposition of a multilayer are:

The workpieces positioned on the workpiece supports of the workpiece conveyor.

The process stations operating continuously.

The workpiece conveyor rotating continuously.

Under operating conditions, the workpieces are automatically processed sequentially, first by the first process station, then by the second process station, etc. until the last process station, and then the cycle is repeated.

The process stations are coupled to the workpiece supports as to provide a process to the workpiece when the workpiece supports pass by the process stations. The process stations are coupled to the workpiece supports, not to the workpieces, because the process stations are capable of delivering a process with or without the presence of the workpieces. Without the workpieces, the process stations will deliver the process onto the workpiece supports.

The process stations can operate continuously without interruption or stop-and-go. In certain aspects, the process stations can operate in pulse mode, meaning on and off. There might be some benefits to stop the process stations when there is no workpieces to process. However, this condition is not necessary, and the on-off operation might present some disadvantages such as wear and tear, disruption of the flow, changing in precursor concentration. In some aspect, the workpiece can be a semiconductor wafer.

To prevent cross contamination, isolation stations can be positioned between the process stations to minimize precursor flow from one process station to another process station. The system can further comprises plasma stations to provide plasma energy, heating station to provide thermal energy and photon energy, laser station to provide laser energy to the workpieces.

Plasma energy can also be provided through the process station by coupling the precursor flow with a plasma generator to excite and energize the precursors. Thermal energy can also be provided through resistive heaters coupled to the workpiece supports to heat the workpieces.

In addition to the basic steps of sequentially processing the workpieces, there are beginning and ending steps disclosed. In the beginning, the step of loading the workpieces onto the workpiece support of the workpiece conveyor is disclosed. In the end, the step of unloading the workpieces from the workpiece support is disclosed. In the beginning, the offsetting of the operation of the process stations is disclosed so that all workpieces have the the same process sequence. The beginning step of offsetting the operation of the process stations is the delay start of subsequent process stations so that all workpieces are being processed first by the first process station. The ideal case is that the first process station is turned on and the workpieces start passing by the first process station to be processed. Then the second process station is turned on and the workpieces pass through the second process station to be processed, after being process by the first process station. Similarly, the third process station is turned on only after the workpieces have been processed by the first and second process stations. In many cases, the timing is not critical. For the case of ALD processing, for example, since the processing time and then number of processing the same step are not a critical variable (meaning that no matter how long and how often the workpiece being processed by the first station, the result is the same), the second station can be turned on right after the workpieces being processed by the first station, or the second station can be turned on after the conveyor makes a complete cycle, or even many cycles.

Similarly, in the end, the offsetting of the operation of the process stations is disclosed so that all workpieces have the same process sequence. The ending step of offsetting the operation of the process stations is the delay stop of subsequent process stations, so that all workpieces are being processed last by the last process station. The ideal case is that the first process station is turned off and the workpieces start passing by the first process station without processed. Then the second process station is turned off and the workpieces pass through the second process station without being processed. Similar to the beginning offset operation, in many cases, the timing is not critical. For the case of ALD processing, for example, since the processing time and then number of processing the same step are not a critical variable, after the first station is turned off, the second station can be turned off right after the workpieces passed un-processed by the first station, or the second station can be turned off after the conveyor makes a complete cycle, or even many cycles.

This sequential process method is different from the prior art sequential or ALD processing method in which the pump/purge step between the processing steps is replaced by a workpiece movement.

The workpiece processing by the first process station can comprise the deposition of a thin film. The characteristic of a deposition process is that the deposited film thickness increases noticeably as a function of processing time. The thin film deposition can occur by the introduction of appropriate precursors through a delivery system in the first compartment. By exposing the workpiece to appropriate precursors under appropriate conditions, a thin film can be deposited on the workpiece. The thickness of the deposited film can be from a monolayer to hundred of nanometers, controllable by various process conditions, such as the process time. A workpiece heater in the first compartment can supply the energy needed for the deposition reaction to take place. The workpiece heater can be a radiative heater or a resistive heater. A plasma or a bias source can also be added to supply the energy needed, or to modify the process characteristics. The process pressure can be sub-atmospheric, controlled by a throttle valve connected to a vacuum pump. The process pressure can be atmospheric, depended on the processes.

The workpiece processing by the first process station can comprise the adsorption of a thin film. The characteristic of an adsorption process is that the adsorbed film thickness does not increases noticeably as a function of processing time. The adsorbed film saturated at a certain thickness, typical less than a monolayer, after a period of processing time. This adsorption characteristics is the characteristics of the ALD process, to ensure a very good conformality of the coated film and to ensure a consistant thickness with a wide process margin. The thickness of the adsorbed film is typical less a monolayer, and is much more difficult to control than the deposited film.

The workpiece processing by the second process station can comprise the reaction of a precursor on the existing film. The workpiece processing by the second process station can comprise the plasma reaction of a precursor on the existing film. The existing film can be from a deposition step or from an adsorption process. The presence of the plasma can fasten the reaction process to improve the throughput. The deposited or adsorbed thin film is treated to form the same materials or a different material.

Implementations of the above aspect may include one or more of the following. The workpiece can be a wafer. The plasma enhances or maintains the thin film conformality. The plasma can be a high density plasma with higher than 5×10⁹ ion/cm³. The reactant can be a metal organic, organic, to form a thin film of metal, metal nitride, or metal oxide. The second reactant can be exposed under high pressure above 100 mT. The first and second reactants react and the reaction creates a new compound. The thin film thickness is less than one atomic layer thickness. The thin film thickness is more than one atomic layer thickness. The thin film thickness can be between a fraction of a nanometer and tens of nanometers. The plasma can be sequentially pulsed for each layer to be deposited. The plasma can be excited with a solid state RF plasma source such as a helical ribbon electrode. The process includes pre-cleaning a surface of a workpiece; stabilizing precursor flow and pressure; exposing the workpiece to a first reactant in the first process station, wherein the first reactant deposits or adsorbed on the workpiece to form a thin film; transferring the workpiece to the second process station; striking the plasma; performing a plasma treatment on the deposited or adsorbed film; exposing the workpiece, coated with the first reactant, to a gaseous second reactant under the plasma treatment, wherein the thin film deposited by the first reactant is treated to form the same materials or a different material. Repeating of the steps deposits a thick film with thickness controlled by the number of repeats.

In another aspect, an apparatus to perform semiconductor processing includes a high density inductive coupled plasma generator to generate plasma; and a process compartment housing the plasma generator. The method can provide deposition of copper metal from Cu hfacI and plasma (gas), Cu hfacII and plasma (gas), CuI₄ and plasma (gas), CuCl₄ and plasma (gas), and organo metallic copper and plasma (gas); of titanium nitride from TDMAT and plasma (gas), TDEAT and plasma (gas), TMEAT and plasma (gas), TiCl₄ and plasma (gas), TiI₄ and plasma (gas), and organo metallic titanium and plasma (gas); of tantalum nitride from PDMAT and plasma (gas), PDEAT and plasma (gas), and organo metallic tantalum and plasma (gas); of aluminum oxide from trimethyl aluminum (TMA) and ozone, TMA and water vapor, TMA and oxygen, organo metallic aluminum and plasma (gas); and other oxides such as hafnium oxide, tantalum oxide, zirconium oxide; wherein gas is one of N₂, H₂, Ar, He, NH₃, and combination thereof.

Implementations of the apparatus can include gas distribution, chuck, vaporizer, pumping port to pump, and port for gas purge.

Advantages of the system may include one or more of the followings. The pump/purge step is minimize, especially with liquid precursors or reactants. There is no extensive pump/purge step to remove all first precursors or reactants before introducing second precursors or reactants because the first and second precursors or reactants are confined in different process stations. There can be a small amount of pump/purge to minimize the amount of cross contamination, occurring during the workpiece transfer, but this pump/purge step is significantly small and can be effectively taken care of by a isolation station. Another advantage is that the chamber cleaning step can be minimize. With the first and second precursors separated, the deposition occurring in the chamber wall is much reduced, leading to less chamber wall cleaning. This is especially useful with metal deposition using ICP plasma, since the non-conducting window of the ICP plasma has to be cleaned of metal deposit. Another advantage is the improvement of uniformity, because a showerhead can be used in the first process station and an ICP plasma in the second process station.

Other advantages of the system may include one or more of the followings. The ICP plasma can use a helical ribbon instead of a coil. The helical ribbon provides a highly uniform plasma and also results in a chamber with a small volume. The system enables high precision etching, deposition or sputtering performance. This is achieved using the pulse modulation of a radio frequency powered plasma source, which enables a tight control the radical production ratio in plasmas, the ion temperature and the charge accumulation. Also, since the time for accumulation of charges in a wafer is on the order of milli-seconds, the accumulation of charges to the wafer is suppressed by the pulse-modulated plasma on the order of micro-seconds, and this enables the suppression of damage to workpieces on the wafer caused by the charge accumulation and of notches caused during the electrode etching process. The system requires that the substrate be heated to a relatively low temperature such as 400 degrees Celsius.

The system can be used for deposition step, such as CVD deposition, ALD deposition, plasma enhanced CVD deposition, metal organic CVD (MOCVD) deposition, sputtering deposition; or for treatment step such as rapid thermal annealing, laser annealing, plasma annealing, desorption; or for etching step such as metal etch, oxide etch, atomic layer etch. Additional stations can be added to the system. An etch station can provide an etch process to the workpiece. A plasma etch station can provide a plasma etch process to the workpiece. A deposition station can deposit a thin film on the workpiece. A sputter deposition system can sputter deposit a thin film on the workpiece. A plasma enhanced deposition can deposit a thin film on the workpiece. A combination of various stations can provide multiplayer sequential process to a workpiece such as a sequence of deposition/etch/deposition/etch processes to enhance the conformality, or to control the film property.

### BRIEF DESCRIPTION OF THE DRAWINGS

FIGS. 1a-1c show prior art sequential processing systems and method.

FIGS. 2a-2c show different views of an embodiment of the present invention assembly line processing system.

FIGS. 3a-3d show different embodiments of precursor distribution of a process station.

FIGS. 4a-4d show different embodiments of a workpiece support.

FIGS. 5a-5d show different embodiments of isolation stations.

FIGS. 6a-6b show different views of an embodiment of the present invention assembly line processing system using sub-atmospheric pressure processing.

FIG. 7 shows an embodiment of the present invention assembly line processing system using a load-or-unload station.

FIGS. 8a-8b show different views of an embodiment of the present invention assembly line processing system using workpiece lift.

FIGS. 9a-9e show different embodiments of precursor delivery systems.

FIGS. 10a-10c show different embodiments of plasma generators.

FIG. 11 shows an embodiments of various stations.

### DESCRIPTION

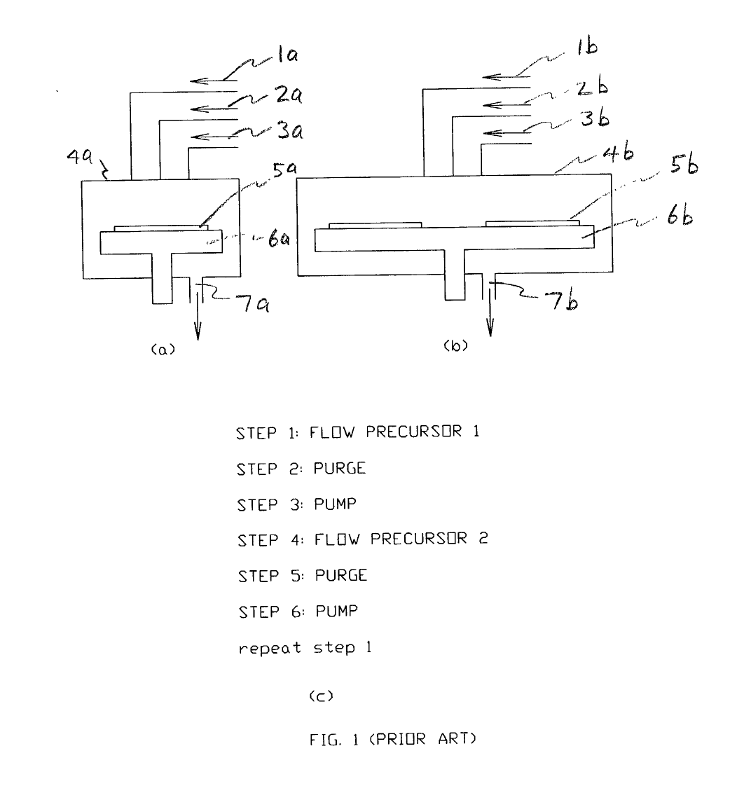

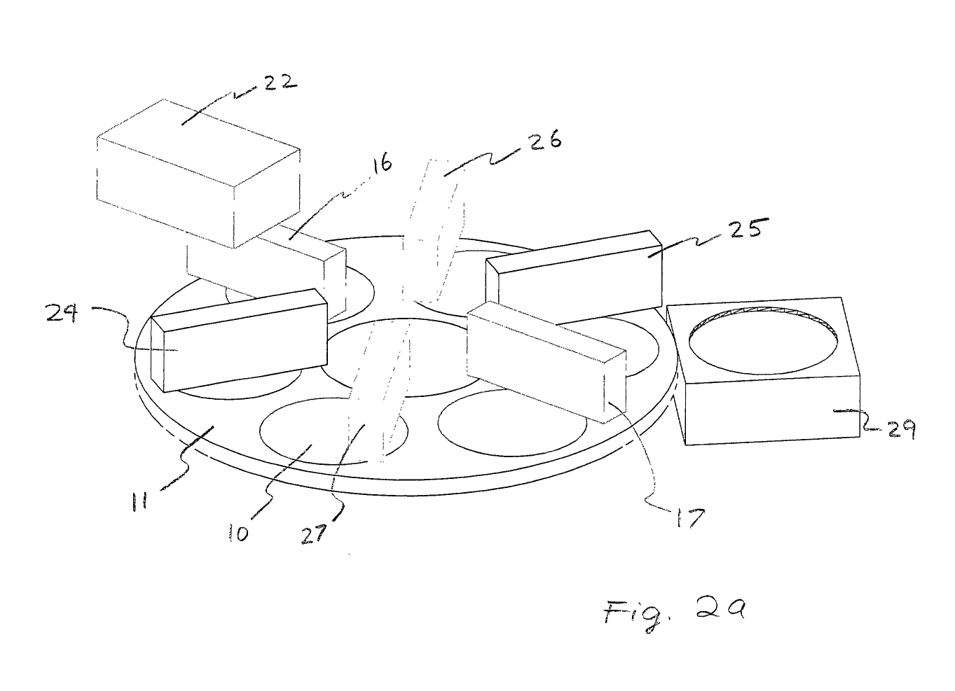

FIGS. 1a-1c show prior art sequential processing systems and method. FIG. 1a shows a single wafer sequential processing system such as the one used in ALD processing. A wafer 5a is positioned on a wafer support 6a inside a process chamber 4a. The process chamber has various inlets 1a, 2a, and 3a. The inlet 1a is for introduce precursor #1, the inlet 2a is for introduce precursor #2, and the inlet 3a is for intruduce purge gas (a non-reactive gas such as inert gas like helium, argon). The chamber is processed under sub-atmospheric pressure with a vacuum pump system connected to the outlet 7a. FIG. 1b show a multiple wafer (batch) sequential processing system. The major different between the single wafer and multiple wafer systems is the number of wafers can be processed at one time. Multiple wafers 5b are position on multiple wafer supports 6b inside processing chamber 4b. The processing chamber 4b has various inlets 1b, 2b, and 3b for precursor #1, precursor #2 and purge gas, together with a pumping outlet 7b. FIG. 1c shows a typical method of sequential processing using prior art sequential processing system. Precursor #1 flows into the process chamber 4a, 4b and reacts on the wafer 5a, 5b. For ALD technique, precursor #1 is adsorbed on the wafer surface. For NLD technique, precursor #1 is deposited on the wafer surface. Then the purge gas is introduced to push the precursor #1 out. A pumping step is then followed to ensure that all precursor #1 is evacuated. Then precursor #2 is introduced, and reacts on the wafer surface. Precursor #2 is then evacuated and then the cycle can be reated until a desired thickness is achieved. The basic operation of the prior art sequential system is the sequential introduction of the precursors.

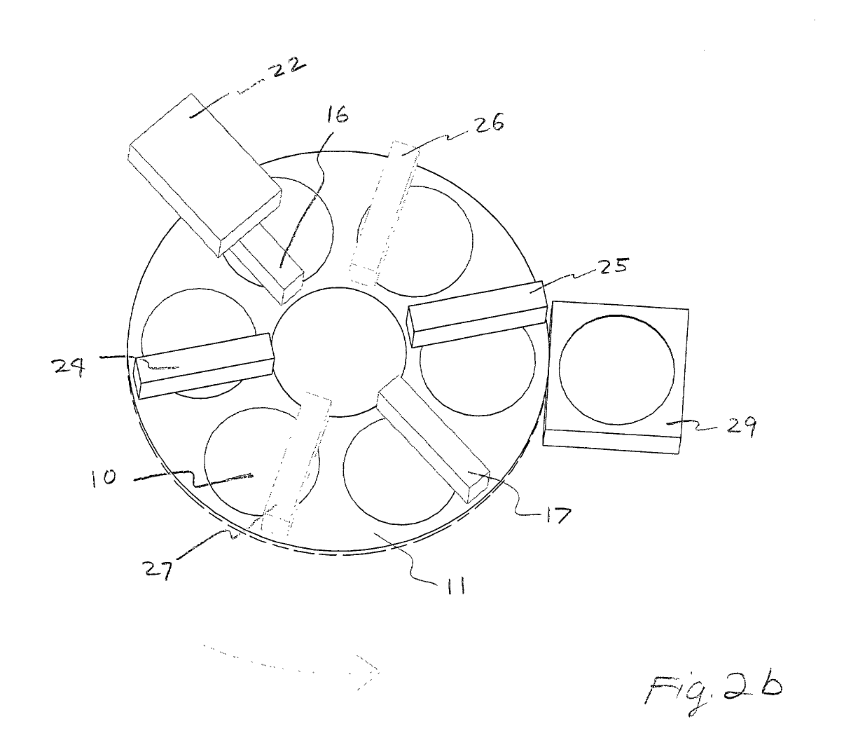

FIGS. 2a-2c show different views of an embodiment of the present invention assembly line processing system. FIGS. 2a, 2b and 2c show different views of the assembly line processing system. Multiple workpieces 10, such as wafers, are positioned on a rotatable workpiece conveyor 11. Two different process stations 16 and 17 are coupled to the workpiece conveyor 11 to deliver various processes to the workpieces 10. Process station 16 further comprises a plasma generator 22 to provide energetic precursors. Two isolation stations 24 and 25 are positioned between the process stations 16 and 17 to minimize the cross contamination between the precursors of process stations 16 and 17. A heating station 26 can provide heating energy to the workpiece, and a plasma station 27 can provide plasma energy to the workpiece. The system further comprises a load-or-unload station 29 to transfer the workpieces in and out of the processing system. When the conveyor 11 is rotated around its axis, the multiple workpieces 10 are also rotated and pass through the multiple stations: the process stations 16, 17, the heating station 26, the plasma station 27 and the isolation stations 24 and 25. FIG. 2c shows a spread-out of the apparatus.

The method of operation for the present invention assembly line processing system is as followed: Precursor #1 is introduced to process station 16 and precursor #2 is introduced to process station 17. The operations of plasma station 2 and heating station 26 are optional. The isolation stations 24 and 25 are operation to prevent mixing of precursors #1 and #2. Conveyor 11 is rotating and the workpieces 10 are processed sequentially, first by precursor #1 from process station 16 and then by precursor #2 from process station 17. The basic operation of the present invention sequential system is the rotation of the conveyor. The precursor flow can be continuous, and need not be sequential as in prior art applications.

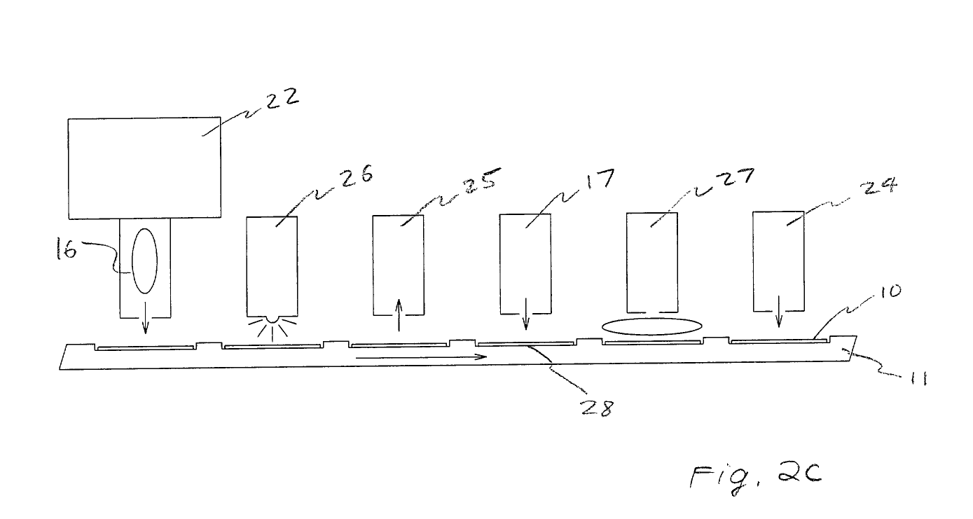

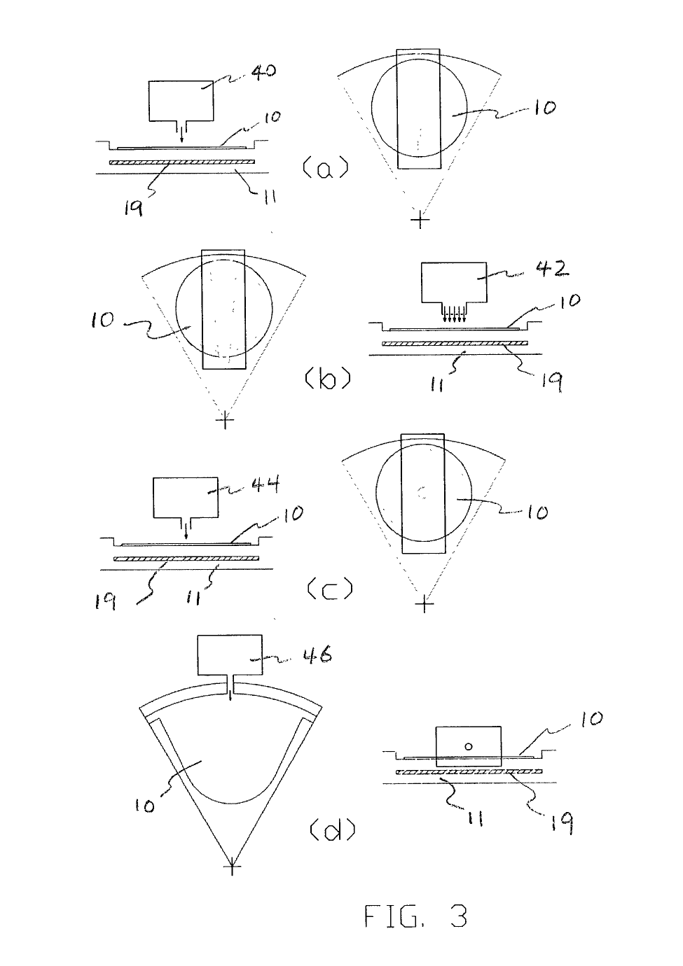

FIGS. 3a-3d show different embodiments of precursor distribution of a process station. In one embodiment (FIG. 3a), the precursor distribution is a linear injector. The process station 40 provides precursor onto a workpiece 10. The workpiece 10 is positioned on a workpiece conveyor 11 with a embedded resistive heater 19 to heat the workpiece to an elevated temperature. In other embodiment (FIG. 3b), the precursor distribution is an oblong showerhead injector, delivered from a process station 42. In other embodiment (FIG. 3c), the precursor distribution is a round hole injector, delivered from a process station 44. In other embodiment (FIG. 3d), the precursor distribution is also a round hole injector, but delivered sideway from a process station 46.

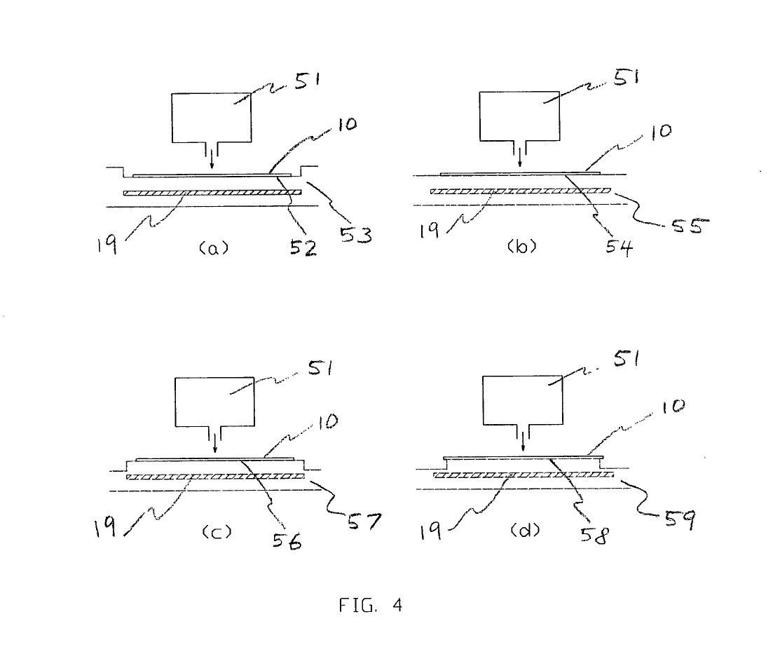

FIGS. 4a-4d show different embodiments of a workpiece support. FIG. 4a shows the workpiece support forming a cavity to contain the workpiece: The process station 51 provides precursor onto the workpiece 10. The workpiece 10 is supported by the workpiece support 52 of the conveyor 53. The conveyor 53 has an embedded resistive heater 19 to heat the workpiece to an elevated temperature. FIG. 4b shows the workpiece support 54 of the conveyor 55 having a flat surface. FIG. 4c shows the workpiece support 56 of the conveyor 57 having a recess surface so that the workpiece 10 is raised above the conveyor 57. The workpiece support 56 is larger than the workpiece 10. FIG. 4d shows the workpiece support 58 of the conveyor 59 having a recess surface so that the workpiece 10 is raised above the conveyor 57. The workpiece support 58 is smaller than the workpiece 10.

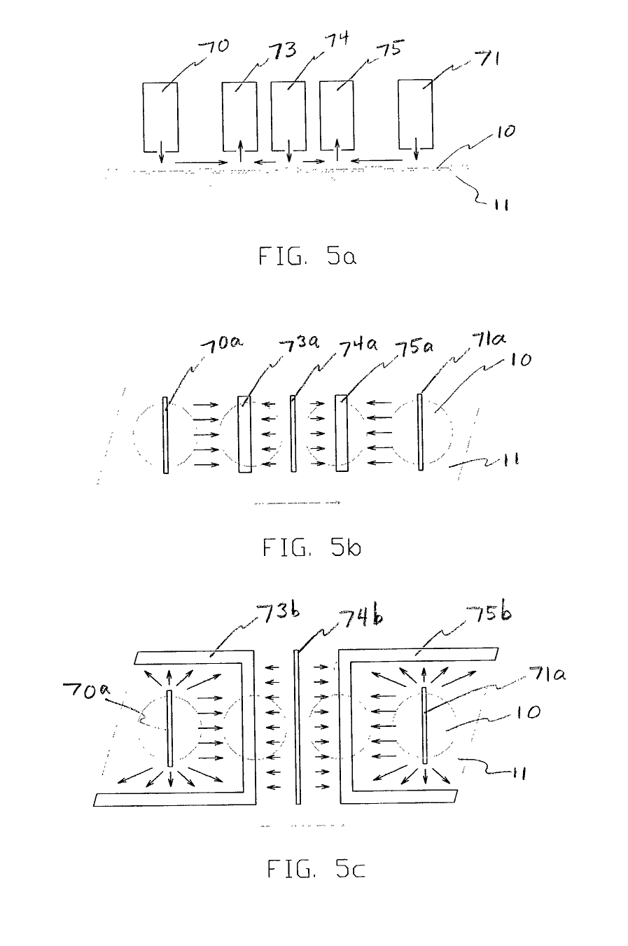

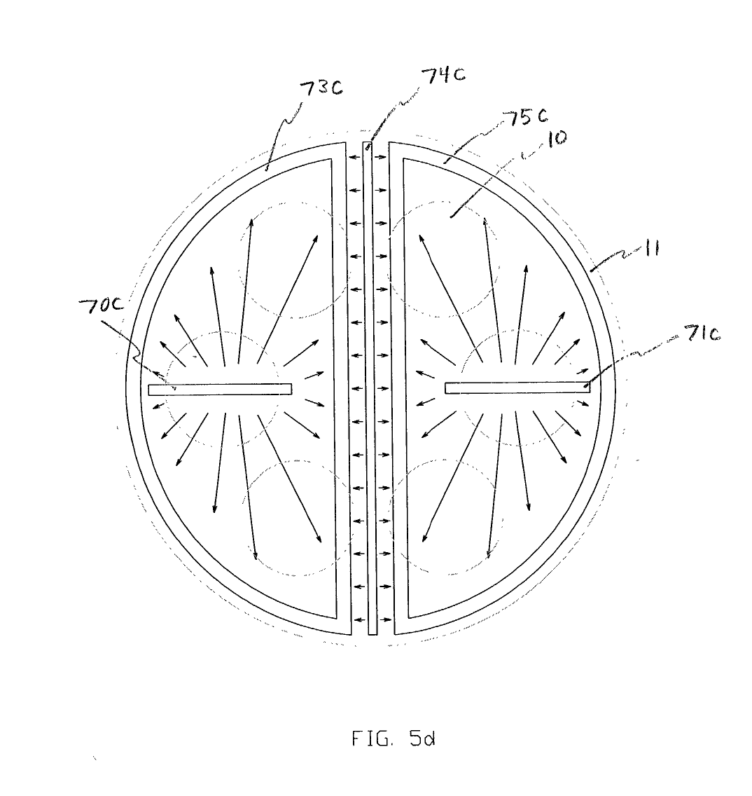

FIGS. 5a-5d show different embodiments of isolation stations. FIG. 5a shows a cross section view of part of the apparatus. The multiple workpieces 10 are positioned on the workpiece conveyor 11 with two process stations 70 and 71. The precursor from process station 70 flow onto the workpiece, and then is captured by the pumping system of the isolation station 73. Similarly, the precursor from process station 71 flow onto the workpiece, and then is captured by the pumping system of the isolation station 75. The purging system of the isolation station 74 creates a gas curtain to prevent cross flow of precursors from process stations 70 and 71. FIG. 5b is the top view of the isolation station. The precursor deliverys of the process stations 70a and 71a are linear injectors to the workpiece 10 on the conveyor 11. The purge system of the isolation 74a creates a gas flow toward the both the pumping systems of the isolation stations 73a and 75a to prevent precursor from the process station 70a to react with the precursor from the process station 71a. FIG. 5c is another embodiment of the isolation station where the pumping systems of the isolation stations 73b and 75b cover completely the process stations 70a and 71a. The purging system of the isolation station 74b keeps the precursors from the process stations 70a and 71a apart. FIG. 5d is another embodiment of the isolation station where the pumping systems of the isolation stations 73c and 75c cover completely the process stations 70c and 71c. The conveyor 11 in FIG. 5d is a rotatable platform, and carries 6 workpieces 10. The purging system of the isolation station 74c keeps the precursors from the process stations 70c and 71c apart.

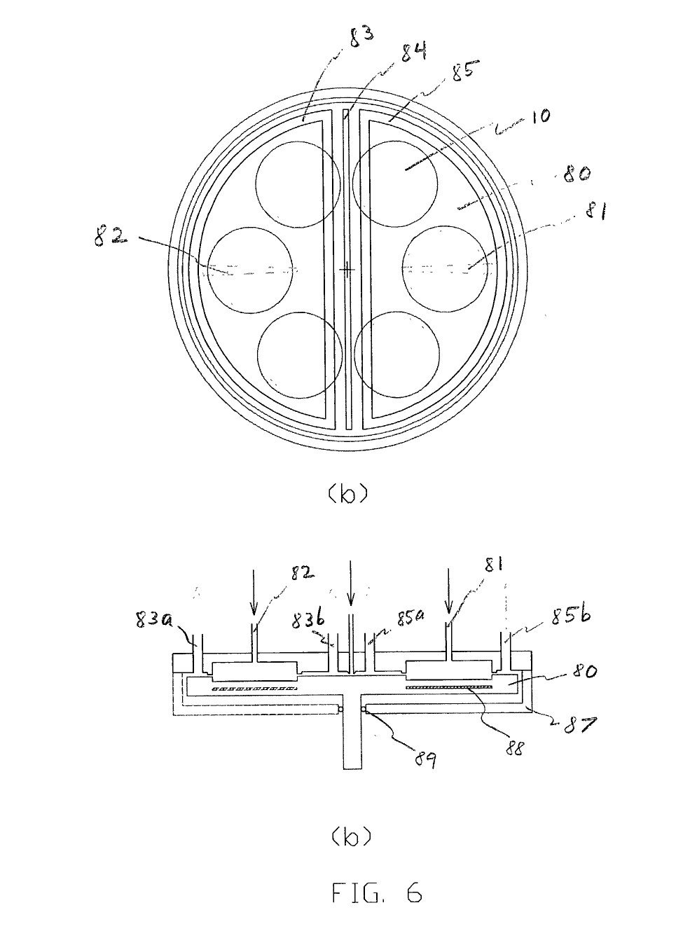

FIGS. 6a-6b show different views of an embodiment of the present invention assembly line processing system using sub-atmospheric pressure processing. The rotatable conveyor 80 carries six workpieces 10 arranged in a circle. There are two process stations 81 and 82 to provide precursors to the workpieces 10. The pumping systems of the isolation stations 83, 83a, 83b and 85, 85a, 85b cover completely the process stations 81 and 82. The purging system of the isolation station 84 creates a gas curtain to further separate the precursors from the process stations 81 and 82. The system further comprises a lower section 87 to maintain sub-atmospheric pressure inside the chamber. The conveyor 80 also has multiple heaters 88 embedded to the workpiece support to heat the workpieces. The conveyor 80 is rotatable and has a sealable rotatable bearing 89 (such as a ferrofluidic seal).

FIG. 7 shows an embodiment of the present invention assembly line processing system using a load-or-unload station. The load-or-unload station comprises a transfer arm 104 in a transfer housing 102. The transfer arm 104 can load or unload the workpiece 100 from the process chamber to the transfer housing 102 through a opening 112. The workpiece 100 then can be load-or-unload to a storage 108 through the opening 110. The storage 108 can store a number of workpieces 106.

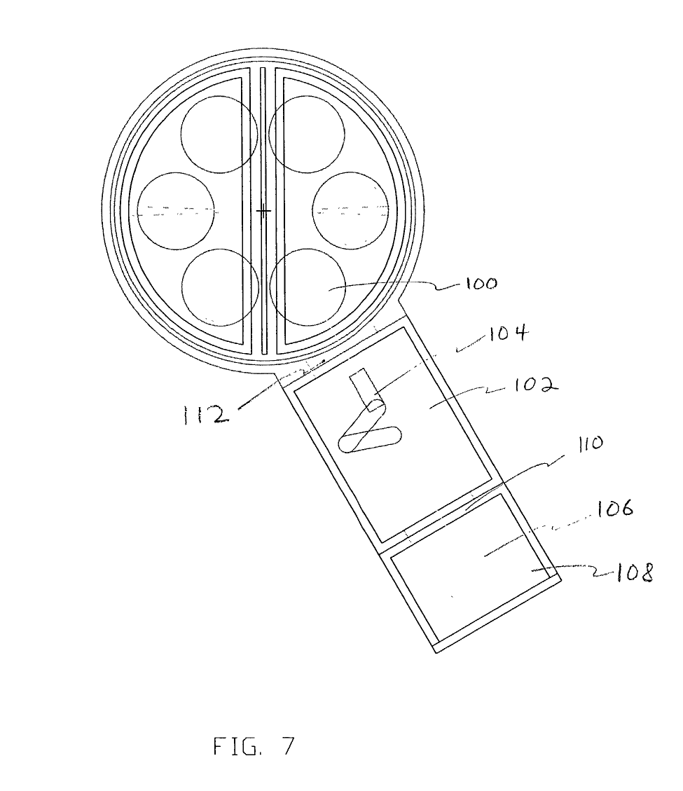

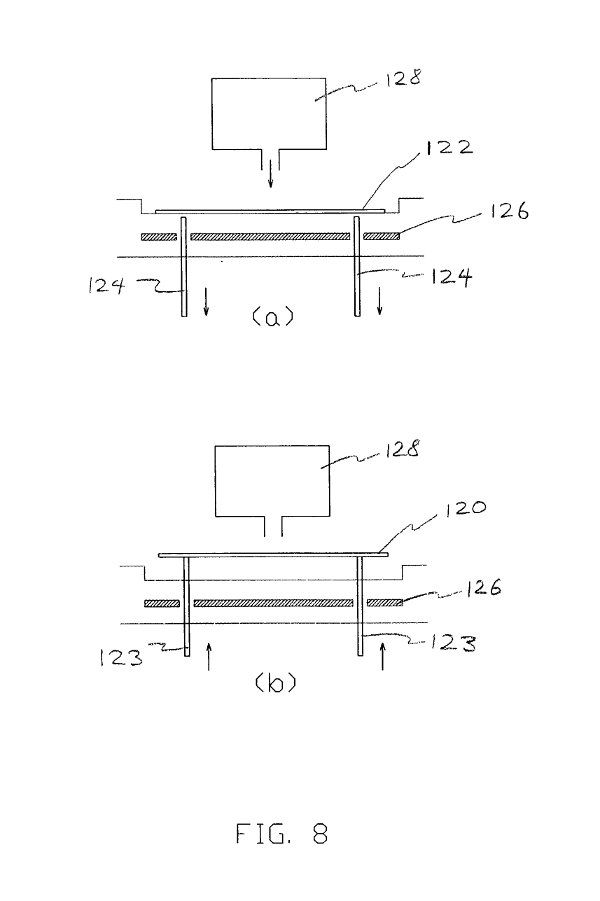

FIGS. 8a-8b show different views of an embodiment of the present invention assembly line processing system using workpiece lift. FIG. 8a show the workpiece 122 in the process position with the workpiece lifts 124 down. The process station 128 is delivering aprecursors to the workpiece 122. The embedded heater 126 to heat the workpiece 122 comprises multiple openings for the insertion of the workpiece lifts 124. FIG. 8b show the workpiece 120 in the up position, ready to be unloaded to the storage. The workpiece lifts 123 are in up position, raise the workpiece 120 up. The process station 128 is not operational at this position since the workpiece 120 is ready to be unloaded.

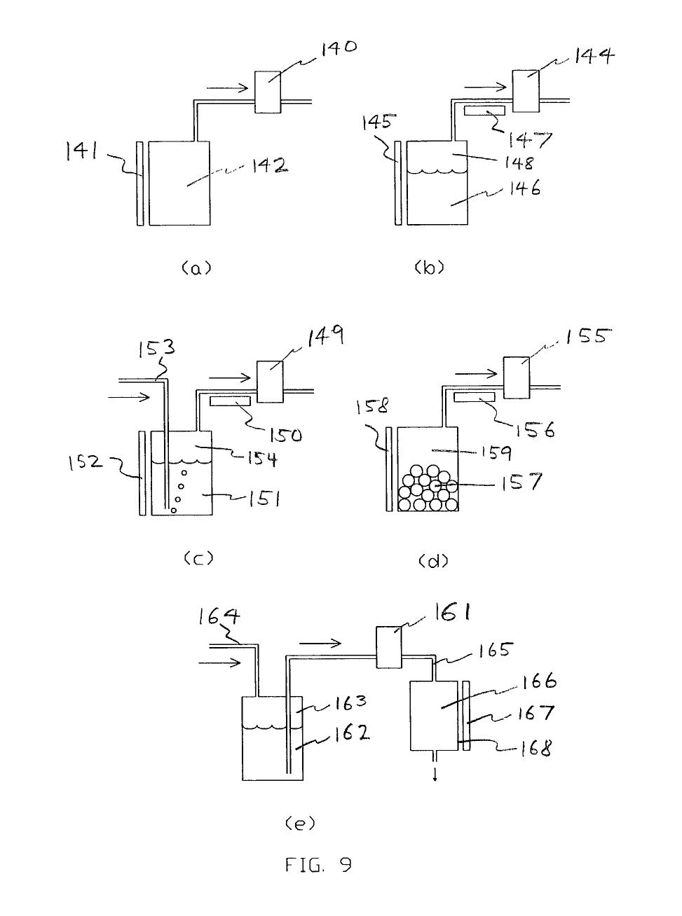

FIGS. 9a-9e show different embodiments of precursor delivery systems. FIG. 9a shows a gaseous precursor delivery system. The gaseous precursor 142 is delivered through the metering device 140 to the workpiece. The heater 141 is used to keep the gaseous precursor at the desired temperature. Typically, the gaseous precursor 142 is kept at a high pressure. FIG. 9b shows a vapor draw liquid precursor delivery system. The precursor is in equilibrium in liquid form 146 and in vapor form 148. The vapor form 148 is draw to a metering device 144 to the workpiece. The heater 145 heats the liquid precursor 146 to raise the partial pressure of the precursor vapor 148. The heater 147 to prevent condensation of the vapor in the delivery line. FIG. 9c shows a bubbler liquid delivery system. The precursor is in equilibrium in liquid form 151 and in vapor form 154. A carrier gas 153 is bubbled through the liquid precursor 151 and carries the precursor vapor through a metering device 149 to the workpiece. The heater 152 heats the liquid precursor 151 to raise the partial pressure of the precursor vapor 154. The heater 150 to prevent condensation of the vapor in the delivery line. FIG. 9d shows a vapor draw solid precursor delivery system. The precursor is in equilibrium in solid form 157 and in vapor form 159. The vapor form 159 is draw to a metering device 155 to the workpiece. The heater 158 heats the solid precursor 157 to raise the partial pressure of the precursor vapor 159. The heater 156 to prevent condensation of the vapor in the delivery line. FIG. 9e shows a liquid injection delivery system. A non-reactive gas 164 exerts pressure 163 to the liquid precursor 162 to push the liquid precursor to a metering device 161. The liquid precursor 165 then travels to a vaporizer 168 to be converted to vapor form 166. The heater 167 heats the vaporizer to supply energy to the liquid precursor to convert to vapor form.

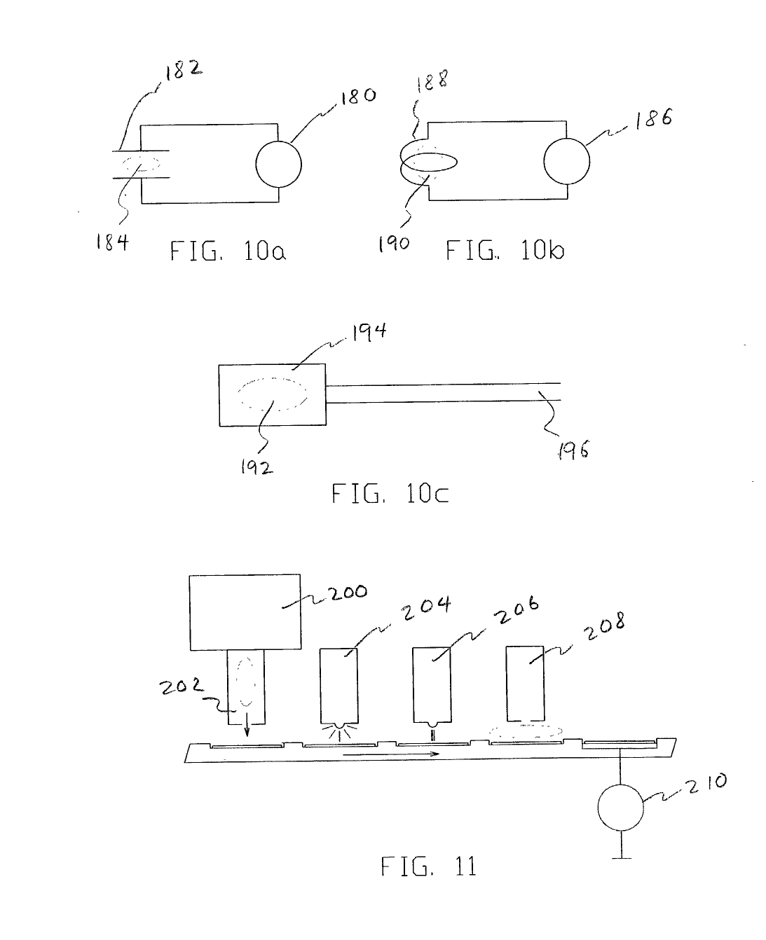

FIGS. 10a-10c show different embodiments of plasma generators. FIG. 10a shows a parallel plate plasma generator. A power source 180 supplies power to a pair of parallel plates 182, generates a high electric field between the parallel plates 182 and excites the gas between the parallel plates 182 to generate a plasma 184. This plasma is highly directional because of the electric field, and has a low ion density. FIG. 10b shows a inductive coupled plasma (ICP). A power source 186 supplies power to an inductive coil 188, generates a high magnetic field inside the coil 188 and excites the gas inside the coil 188 to generate a plasma 190. This plasma has no directional and a high ion density. FIG. 10c shows a remote plasma system. The plasma generator 194 generates a plasma 192 upstream of the flow and carries the excited and energetic species to a downstream 196. This plasma has little kinetic energy and a fairly uniform distribution of energy. Plasma can be generated by a power source with radio frequency (RF) such as a parallel plate plasma, inductive coupled plasma, remote plasma or with microwave frequency (MW) such as a remote plasma or a microwave plasma.

FIG. 11 shows an embodiments of various stations. The first station is a plasma process station 202. The process station 202 has a plasma generator 200 to excite the precursor before deliver to the workpiece. The second station is a heating station 204. The heating station 204 delivers thermal energy and photon energy to the workpiece for heating and for reaction acceleration. The third station is a laser station 206. The laser station 206 delivers laser energy to the workpiece for heating and for reaction acceleration. The fourth station is a plasma station 208. The plasma station 208 delivers plasma energy to the workpiece. A bias source 210 is also shown for biasing the workpiece for direction control of the charged species.

What is claimed is:

1. An assembly line processing system apparatus for sequentially and repeatably processing a plurality of workpieces, the apparatus comprising:
a movable workpiece conveyor defining a closed-loop processing path,
the movable workpiece conveyor comprising multiple workpiece supports each adapted to carry a workpiece,
wherein the movable workpiece conveyor is capable of continuously and repeatably moving the workpiece supports along the closed-loop processing path; and
at least two process stations providing two different workpiece processes onto the workpieces,
the process stations being positioned along the closed-loop processing path,
each workpiece process comprising delivering a plurality of precursors onto the workpieces,
wherein the process stations are capable of providing sequential workpiece processes onto the workpiece when the workpiece is moving along the closed-loop processing path;
wherein by repeatably moving the movable workpiece conveyor along the closed-loop processing path with the process stations under operating conditions, a plurality of workpieces positioned on the workpiece conveyor are processed in an assembly line fashion with the workpieces being processed sequentially by different process stations and the workpieces being processed a plurality of cycles by the closed-loop processing path.

2. An apparatus as in claim 1, wherein the workpiece is a semiconductor wafer.

3. An apparatus as in claim 1, wherein the precursors are delivered from the side of the workpiece.

4. An apparatus as in claim 1, wherein the precursors are delivered from the top of the workpiece.

5. An apparatus as in claim 1, wherein the precursors are delivered through a round injector.

6. An apparatus as in claim 1, wherein the precursors are delivered through a linear injector.

7. An apparatus as in claim 1, wherein the precursors are delivered through a showerhead injector.

8. An apparatus as in claim 1 further comprising a plurality of isolation stations positioned between the process stations to minimize cross contamination between the process stations.

9. An apparatus as in claim 7, wherein the isolation station comprises a plurality of pumping outlets.

10. An apparatus as in claim 7, wherein the isolation station comprises a plurality of purging outlets.

11. An apparatus as in claim 7, wherein the isolation station comprises a plurality of pumping outlets and a plurality of purging outlets.

12. An apparatus as in claim 1, wherein the workpiece support is recessed to create a cavity for the workpiece.

13. An apparatus as in claim 1, wherein the workpiece support is flushed and the workpiece is exposed.

14. An apparatus as in claim 1 further comprising
an enclosed chamber covering the movable workpiece conveyor; and
a chamber vacuum pump system capable of maintaining the enclosed chamber at a sub-atmospheric pressure;
wherein the chamber vacuum system allows the assembly line processing system to be processed under sub-atmospheric pressure.

15. An apparatus as in claim 1, wherein the movable workpiece conveyor is a rotatable platform.

16. An apparatus as in claim 1 further comprising a plurality of load-or-unload stations, wherein the workpieces can be loaded or unloaded between the load-or-unload stations and the workpiece supports.

17. An apparatus as in claim 1 further comprising a plurality of workpiece heaters coupled to the workpiece supports.

18. An apparatus as in claim 1 further comprising a plurality of heating stations providing thermal energy to the workpieces.

19. An apparatus as in claim 1 further comprising a plurality of laser stations providing laser energy to the workpieces.

20. An apparatus as in claim 1 further comprising a plurality of workpiece lifts to separate the workpieces from the workpiece supports.

21. An apparatus as in claim 1, wherein the precursors to be delivered onto the workpieces are stored in gaseous form.

22. An apparatus as in claim 1, wherein the precursors to be delivered onto the workpieces are stored in liquid form and delivered onto the workpieces in vapor form.

23. An apparatus as in claim 1, wherein the precursors to be delivered onto the workpieces are stored in solid form and delivered onto the workpieces in vapor form.

24. An apparatus as in claim 1 further comprising a plurality of plasma generator stations providing plasma energy to the workpieces.

25. An apparatus as in claim 24, wherein the plasma generators comprises a inductive coupled plasma source.

26. An apparatus as in claim 24, wherein the plasma generators comprises a remote plasma source.

27. An apparatus as in claim 24, wherein the plasma generators comprises a microwave plasma source.

28. An apparatus as in claim 24, wherein the plasma generators comprises a parallel plate plasma source.

29. An apparatus as in claim 1 further comprising a plurality of plasma generators coupled to the process stations to energize the precursors.

30. An apparatus as in claim 1 further comprising a plurality of bias power sources compled to the workpiece support.

31. An apparatus as in claim 30, wherein the bias power sources comprises an RF power source.

32. An apparatus as in claim 30, wherein the bias power sources comprises an DC power source.

33. An assembly line processing system apparatus for sequentially and repeatably processing a plurality of workpieces, the apparatus comprising:
a rotatable workpiece conveyor defining a closed-loop processing path,
the rotatable workpiece conveyor comprising multiple workpiece supports each adapted to carry a workpiece,
wherein the rotatable workpiece conveyor is capable of continuously and repeatably moving the workpiece supports along the closed-loop processing path;
at least two process stations providing two different workpiece processes onto the workpieces,
the process stations being positioned along the closed-loop processing path, each workpiece process comprising delivering a plurality of precursors onto the workpieces,
wherein the process stations are capable of providing sequential workpiece processes onto the workpiece when the workpiece is moving along the closed-loop processing path;
a motor system to move the rotatable workpiece conveyor along the closed-loop processing path;
a plurality of isolation stations positioned between the process stations to minimize cross contamination between the process stations;
an enclosed chamber covering the rotatable workpiece conveyor, the enclosed chamber being vacuum-tight to allow the assembly line processing system to be processed under sub-atmospheric pressure;and
a plurality of load-or-unload stations;
wherein the workpieces can be loaded or unloaded between the load-or-unload stations to the workpiece supports;
wherein by repeatably moving the rotatable workpiece conveyor along the closed-loop processing path with the process stations under operating conditions, a plurality of workpieces positioned on the rotatable workpiece conveyor are processed in an assembly line fashion with the workpieces being processed sequentially by different process stations and the workpieces being processed a plurality of cycles by the closed-loop processing path.

34. An apparatus as in claim 33, wherein the workpiece is a semiconductor wafer.

35. An apparatus as in claim 33, wherein the precursors are delivered through a linear injector.

36. An apparatus as in claim 33, wherein the isolation station comprises a plurality of pumping outlets and a plurality of purging outlets.

37. An apparatus as in claim 33 further comprising a plurality of workpiece heaters coupled to the workpiece supports.

38. An apparatus as in claim 33 further comprising a plurality of heating stations proving thermal energy to the workpieces.

39. An apparatus as in claim 33 further comprising a plurality of laser stations proving laser energy to the workpieces.

40. An apparatus as in claim 33 further comprising a plurality of workpiece lifts to separate the workpieces from the workpiece supports.

41. An apparatus as in claim 33, wherein the precursors to be delivered onto the workpieces are stored in gaseous form.

42. An apparatus as in claim 33, wherein the precursors to be delivered onto the workpieces are stored in liquid form and delivered onto the workpieces in vapor form.

43. An apparatus as in claim 33, wherein the precursors to be delivered onto the workpieces are stored in solid form and delivered onto the workpieces in vapor form.

44. An apparatus as in claim 33 further comprising a plurality of plasma generator stations providing plasma energy to the workpieces.

45. An apparatus as in claim 33 further comprising a plurality of plasma generators coupled to the process stations to energize the precursors.

46. An apparatus as in claim 33 further comprising a plurality of bias power sources compled to the workpiece support.

47. An apparatus as in claim 33, wherein one of the process stations further comprises a deposition system to deposit a thin film on the workpieces.

48. An apparatus as in claim 33, wherein one of the process stations further comprises a treatment system to modify the property of an existing thin film on the workpieces.

49. An apparatus as in claim 33, wherein one of the process stations further comprises a etching system to etch an existing thin film on the workpieces.
